(19) United States
(12) Patent Application Publication
(10) Pub. No.: US 2007/0126914 A1
(43) Pub. Date: Jun. 7, 2007

(54) Solid state imaging device

(76) Inventors: Tomoko Komatsu, Kyoto (JP); Tomoki Masuda, Osaka (JP); Yasuo Takeuchi, Osaka (JP); Nobukazu Teranishi, Tokyo (JP); Yutaka Harada, Kyoto (JP); Kiyokazu Itoi, Osaka (JP); Akiyoshi Kohno, Kanagawa (JP)

Correspondence Address: MCDERMOTT WILL & EMERY LLP, 600 13TH STREET, N.W., WASHINGTON, DC, 20005-3096, US

(21) Appl. No.: 11/585,891

(22) Filed: Oct. 25, 2006

(30) Foreign Application Priority Data
Nov. 18, 2005 (JP) 2005-334483

(51) Int. Cl. H04N 5/225

(52) U.S. Cl. 348/340

(57) ABSTRACT

A solid state imaging element including light receiving elements and microlenses is placed in a recess of a ceramic package. A black resin fills space between the ceramic package and the solid state imaging element.

### BACKGROUND OF THE INVENTION

1. Field of the Invention

The present invention relates to a solid state imaging device including a solid state imaging element and a transparent component for protecting the solid state imaging element.

2. Description of Related Art

As an example of a solid state imaging device using a CCD (charge coupled device), there has been known a solid state imaging device including a solid state imaging element arranged in a ceramic package. In such a solid state imaging device, a transparent component is provided to cover the top of the ceramic package. In recent years, a technique has been proposed that the solid state imaging element and the transparent component arranged thereon are sealed in the package with a resin (e.g., see Japanese Unexamined Patent Publication No. 2002-261260).

FIG. 7 is a sectional view illustrating a conventional solid state imaging device. In the conventional solid state imaging device shown in FIG. 7, a solid state imaging element 113 is placed in a recess 111a of a layered ceramic package 111 made of a stack of two or more ceramic plates.

The solid state imaging element 113 is provided with a light receiving element 113a. Input/output portions 113b are formed in parts of a peripheral region 113A outside the light receiving element 113a.

Electrode pads 113c are formed on the surfaces of the input/output portions 113b. The electrode pads 113c are connected to internal leads 111b in the layered ceramic package 111 via wires 117. Further, a cover glass 123 is arranged on the top surface of the solid state imaging device 113 and a light shield layer 121 is formed thereon. The light shield layer 121 is formed to cover the peripheral portion of the top surface, end faces (sides) and the peripheral portion of the bottom surface of the cover glass 123. The light shield layer 121 prevents light reflected on the wires 117 from entering the light receiving element 113a. A sealant 127 fills the space between the cover glass 123 and the layered ceramic package 111.

### SUMMARY OF THE INVENTION

In the conventional solid state imaging device described above, however, light incident on the cover glass 123 is reflected on the end faces thereof to enter the light receiving element 113a.

As a solution to this problem, the present invention has been achieved. An object of the present invention is to reduce the light reflection on the end faces of a transparent component such as the cover glass.

A solid state imaging device according to a first aspect of the present invention includes a solid state imaging element including a plurality of light receiving elements and a plurality of microlenses formed above the light receiving elements; a transparent component formed above the microlenses; and a black resin provided on end faces of the transparent component.

In the solid state imaging device according to the first aspect of the present invention, light incident on the transparent component from the outside of the solid state imaging element is likely to be absorbed in the black resin to reduce the reflection. In the conventional device, light is reflected on the end faces of the transparent component to enter the light receiving element. However, with the structure of the present invention, the amount of reflected light entering the light receiving element is reduced, thereby preventing the occurrence of flare.

The solid state imaging device according to the first aspect of the present invention may further include a package having a recess, wherein the solid state imaging element and the transparent component may be placed in the recess of the package and the black resin fills space between the package and a combination of the solid state imaging element and the transparent component.

In such a case, the black resin is used as a resin for filling the space in the package. Therefore, the black resin is provided on the end faces of the transparent component without increasing the number of steps.

As to the solid state imaging device according to the first aspect of the present invention, the black resin may contain a resin and particles for blocking visible light.

The particles for blocking the visible light may be a black pigment, a black dye or carbon particles.

As to the solid state imaging device according to the first aspect of the present invention, the black resin may also cover the edge of the top of the transparent component. In such a case, the amount of light that reached the end faces of the transparent component is reduced, thereby reducing the amount of light reflected on the end faces of the transparent component.

As to the solid state imaging device according to the first aspect of the present invention, it is preferred that the periphery of the transparent component is positioned outside the periphery of a region where the microlenses are provided when viewed in plan and the solid state imaging device satisfies
L≧(t₀+t₁)tan θ

wherein L is a horizontal distance from the end face of the transparent component to the periphery of the region where the microlenses are provided, θ is a maximum incident angle with respect to the transparent component, to is a thickness of the transparent component and t₁ is a vertical distance from the top surface of the light receiving element to the bottom surface of the transparent component. The value (t₀+t₁)tan θ signifies a maximum value of a horizontal distance which the light reflected on the end face of the transparent component travels along a plane where the light receiving element is formed. In theory, if the value L is equal to or exceeds the maximum value, the light does not enter the light receiving elements no matter which part of the end face of the transparent component the light reaches. Therefore, the entrance of the reflected light into the light receiving elements is prevented with high reliability.

As to the solid state imaging device according to the first aspect of the present invention, at least part of the transparent component may be tapered upward. In such a case, as compared with the case where the width of the transparent component is kept unchanged, the reflection of light on the end faces of the transparent component is less likely to occur. The tapered shape is obtained by beveling the corners of the transparent component.

As to the solid state imaging device according to the first aspect of the present invention, an anti-reflection film having a refractive index intermediate between the refractive indices of the transparent component and the black resin may be provided between the end face of the transparent component and the black resin. In such a case, the light reached and reflected on the end faces of the transparent component is prevented from entering the light receiving elements with high reliability.

If the anti-reflection films are formed, it is preferred that a film having a refractive index intermediate between the refractive indices of the transparent component and air is formed on the top surface of the transparent component. The refractive index of said film may be different from that of the anti-reflection film.

As to the solid state imaging device according to the first aspect of the present invention, the end faces of the transparent component may have rough surfaces, respectively. In such a case, light reached the end faces of the transparent component is scattered by the rough surfaces, thereby preventing the light from entering the light receiving elements with high reliability.

As to the solid state imaging device according to the first aspect of the present invention, the transparent component and the black resin may have substantially the same refractive index. In such a case, light reached the end faces of the transparent component is more likely to be absorbed by the black resin. Even if the refractive indices of the transparent component and the black resin are different from each other only by the amount of error, they are regarded as “substantially the same”.

### BRIEF DESCRIPTION OF THE DRAWINGS

FIG. 1 is a sectional view illustrating the structure of a solid state imaging device according to a first embodiment of the present invention.

FIG. 2 is a view illustrating a proper size of a transparent component to be arranged on a solid state imaging element.

FIGS. 3A and 3B are plan views illustrating the positional relationship between a transparent component and an effective pixel region.

FIG. 4 is a sectional view illustrating the structure of a solid state imaging device according to a third embodiment of the present invention.

FIG. 5A is a sectional view illustrating an enlargement of a transparent component of a solid state imaging device according to a fourth embodiment of the present invention, FIG. 5B is a sectional view illustrating the overall structure of the solid state imaging device according to the fourth embodiment and FIG. 5C is a sectional view illustrating a modified example of the transparent component according to the fourth embodiment.

FIG. 6A is a sectional view illustrating the structure of a first solid state imaging device according to a fifth embodiment of the present invention and FIG. 6B is a sectional view illustrating the structure of a second solid state imaging device according to the fifth embodiment of the present invention.

FIG. 7 is a sectional view illustrating a conventional solid state imaging device.

### DETAILED DESCRIPTION OF THE INVENTION

Hereinafter, detailed explanation of embodiments of the present invention is provided with reference to the drawings.

### First Embodiment

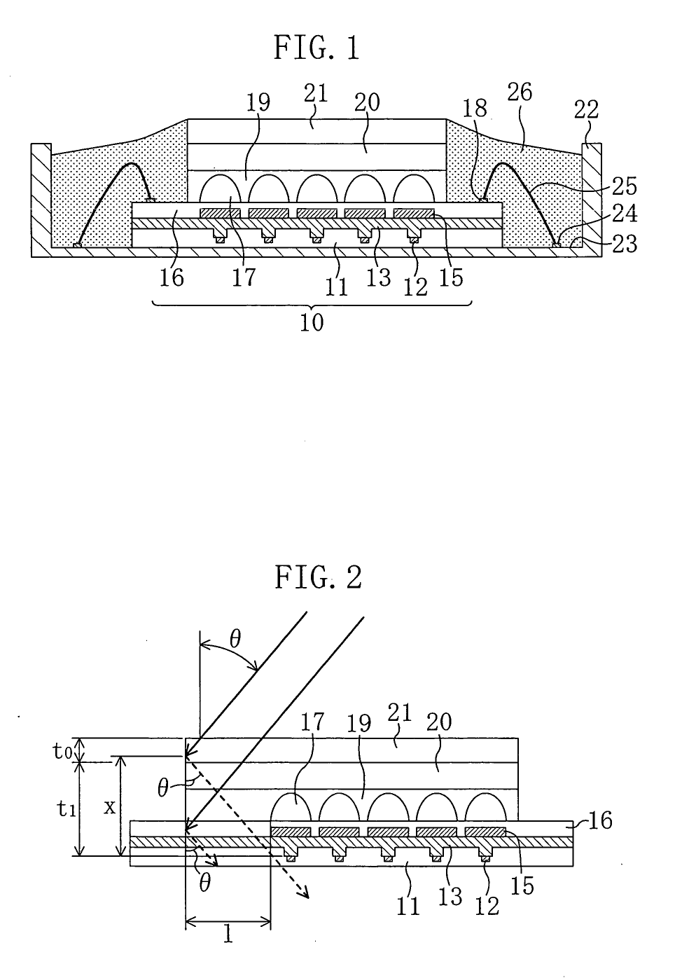

FIG. 1 is a sectional view illustrating the structure of a solid state imaging device according to a first embodiment of the present invention. In the solid state imaging device of the present embodiment, light receiving elements (photodiodes) 12 for converting incident light into an electronic signal are formed on the bottom of recesses formed on a pixel-by-pixel basis in the surface of a substrate 11 for forming solid state imaging elements. A first planarization film 13 is formed on the substrate 11 and the light receiving elements 12 to make the uneven surface of the substrate 11 flat. The first planarization film 13 may be made of an acrylic resin. On the first planarization film 13, color filters 15 are formed in the same arrangement as the light receiving elements 12 when viewed in plan. A second planarization film 16 is formed on the color filters 15 to remove unevenness caused by the color filters 15. The second planarization film 16 may be made of an acrylic resin. Further, microlenses 17 are formed on the second planarization film 16 in the same arrangement as the color filters 15 when viewed in plan. These components constitute a solid state imaging element 10.

The substrate 11 includes a light receiving region in which the light receiving elements 12 are arranged in a matrix and a peripheral region outside the light receiving region. The peripheral region is provided with electrode pads 18 electrically connected to interconnections of the solid state imaging elements. Though not shown, interconnections and protection circuits for protecting the light receiving elements 12 are also formed in the peripheral region of the substrate 11.

On the second planarization film 16 and the microlenses 17, a low refractive layer 19 made of a fluorine-containing resin is formed. A transparent component 21 made of glass is formed above the low refractive layer 19 with an adhesive layer 20 interposed therebetween.

The substrate 11 is placed on the bottom of a recess 23 of a ceramic package 22 formed of a stack of two or more ceramic plates. The substrate 11 is bonded to the bottom of the recess 23 of the ceramic package 22 with an adhesive. The ceramic package 22 includes external leads (not shown) connected to the outside thereof and input/output portions 24 for inputting/outputting signals to/from the solid state imaging element.

The electrode pads 18 used for the solid state imaging element 10 and the input/output portions 24 of the ceramic package 22 are electrically connected via wires 25 made of gold or the like.

In the recess 23 of the ceramic package 22, a black resin 26 fills space around the substrate 11, low refractive layer 19, adhesive layer 20 and transparent component 21. The wires 25 are fixed by being sealed in the black resin 26. In the present specification, the black resin 26 is a resin colored in black. Specifically, the black resin 26 contains a resin and particles for blocking (or absorbing) visible light. The particles make the color of the resin 26 black. The particles for blocking the visible light may be a black pigment, a black dye or carbon particles. Alternatively, red, green and blue pigments or dyes may be mixed therein.

If a large amount of the particles is mixed in the resin, the color of the black resin 26 becomes dark, thereby improving light absorbance. However, in the present invention, any resin added with the particles and therefore colored in black is referred to as a “black resin” and the concentration of the particles is not questioned. Even if the amount of the particles added is small, the light absorbance improves as compared with a conventional resin free from the particles. The resin used herein may be an epoxy resin, a silicone resin or an acrylic resin, but any general resin may be applicable.

The filling of the ceramic package 22 with the black resin 26 is carried out by a technique using a dispenser, for example. The solid state imaging device 10 may be formed by a technique known in the art.

As described above, according to the present embodiment, the end faces (sides) of the transparent component 21 are covered with the black resin 26. Accordingly, light incident on the transparent component 21 from the outside of the solid state imaging element is more likely to be absorbed in the black resin 26, i.e., less likely to cause reflection. In a conventional manner, the light is reflected on the end faces of the transparent component 21 to enter the solid state imaging element. However, with the structure of the present embodiment, the amount of reflected light entering the solid state imaging element is reduced, thereby preventing the occurrence of flare. Further, since the resin itself for filling the space in the ceramic package 22 has been required in the conventional technique, the effect of reducing the amount of reflected light entering the solid state imaging element is achieved without increasing the number of the manufacturing steps.

### Second Embodiment

In the present embodiment, an appropriate size of the transparent component is considered. This consideration is based on the assumption that the light is not completely absorbed in the black resin at the end faces of the transparent component but partially reflected. In the present invention, however, the light reached the end faces of the transparent component may be absorbed completely by the black resin. FIG. 2 is a view illustrating the appropriate size of the transparent component arranged on the solid state imaging element.

In FIG. 2, t₀ denotes the thickness of the transparent component 21 and t₁ denotes a distance from the top surface of the light receiving elements 12 to the bottom surface of the transparent component 21. Further, a maximum incident angle with respect to the transparent component 21 is regarded as θ (an angle formed by the incident light and the normal of the transparent component 21). In this case, if the top surface and the end face of the transparent component 21 form a right angle, light incident on the transparent component 21 from above is reflected by the end face of the transparent component 21 at θ. A distance l that the light reached and reflected on the end face travels in the direction parallel to the plane where the light receiving elements 12 are formed (horizontal distance from the end face of the transparent component 21 to the light receiving elements 12) is expressed by the following equation (1):
l=x tan θ (1)
wherein x is a vertical distance from the top surface of the light receiving elements to part of the end face of the transparent component 21 at which the light arrived.

The value l will be the maximum when x=t₀+t₁, i.e., when the light reaches the topmost part of the end face of the transparent component 21. When this is substituted into the equation (1), the following equation (2) is obtained:
lₘₐₓ=(t₀+t₁)tan θ (2)

According to the equation (2), if a distance L from the periphery of an effective pixel region where the light receiving elements 12 are provided to the end face of the transparent component 21 is not smaller than (t₀+t₁)tan θ, the light will not enter the light receiving elements 12 no matter which part of the end face of the transparent component 21 the light reaches. Therefore, if the transparent component 21 is arranged to meet the condition, the entrance of the reflected light into the light receiving elements 12 is surely prevented.

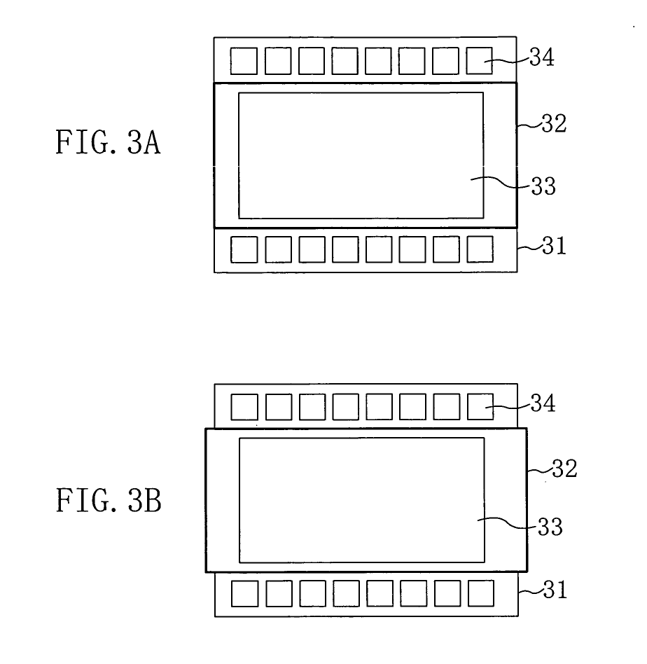

FIGS. 3A and 3B are plan views illustrating the positional relationship between the transparent component and the effective pixel region. As shown in FIGS. 3A and 3B, an effective pixel region 33 is provided on a substrate 31 for forming solid state imaging elements. Though not shown, solid state imaging elements as those shown in FIG. 1 are formed in the effective pixel region 33. The boundary of the effective pixel region 33 divides a region where the microlenses are formed and a region where the microlenses are not formed.

On the substrate 31, bonding pads 34 are formed on two of the four sides surrounding the effective pixel region 33 (top and bottom sides in the drawing). The other two sides may be used to adjust the size of the transparent component 32. By the adjustment of the size of the transparent component 32, the distance from the effective pixel region 33 to the end face of the transparent component 32 is made large.

FIG. 3A shows the transparent component 32 having the same width (horizontal width as viewed in the drawing) as that of the substrate 31. In this case, if the distance from the end face of the transparent component 32 to the effective pixel region 33 is (t₀+t₁)tan θ or more, the entrance of reflected light into the light receiving elements is surely prevented.

FIG. 3B shows the transparent component 32 having a width larger than that of the substrate 31. Also in this case, if the distance from the end face of the transparent component 32 to the effective pixel region 33 is (t₀+t₁)tan θ or more, the entrance of reflected light into the light receiving elements is surely prevented.

### Third Embodiment

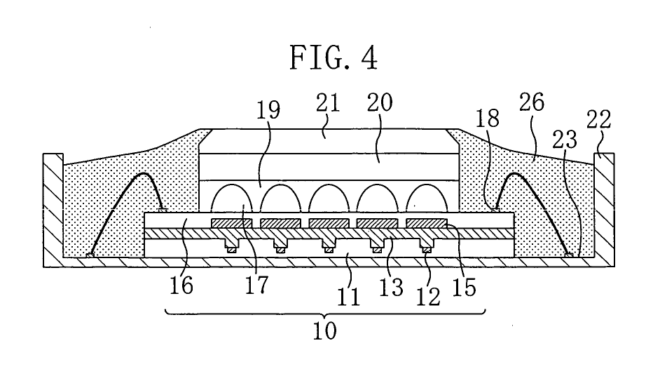

FIG. 4 is a sectional view illustrating the structure of a solid state imaging device according to a third embodiment of the present invention. In the solid state imaging device of the present embodiment, the edge of the top of the transparent component 21 is beveled. That is, the transparent component 21 is tapered upward when viewed in section. The beveled part of the transparent component 21 is covered with the black resin. The edge of the top of the transparent component 21 may be rounded or have uneven surfaces. Other features of the solid state imaging device of the present embodiment are the same as those of the solid state imaging device of the first embodiment. Therefore, detailed explanation is omitted.

With the structure of the present embodiment, the reflection of light at the end faces of the transparent component 21 is less likely to occur.

### Fourth Embodiment

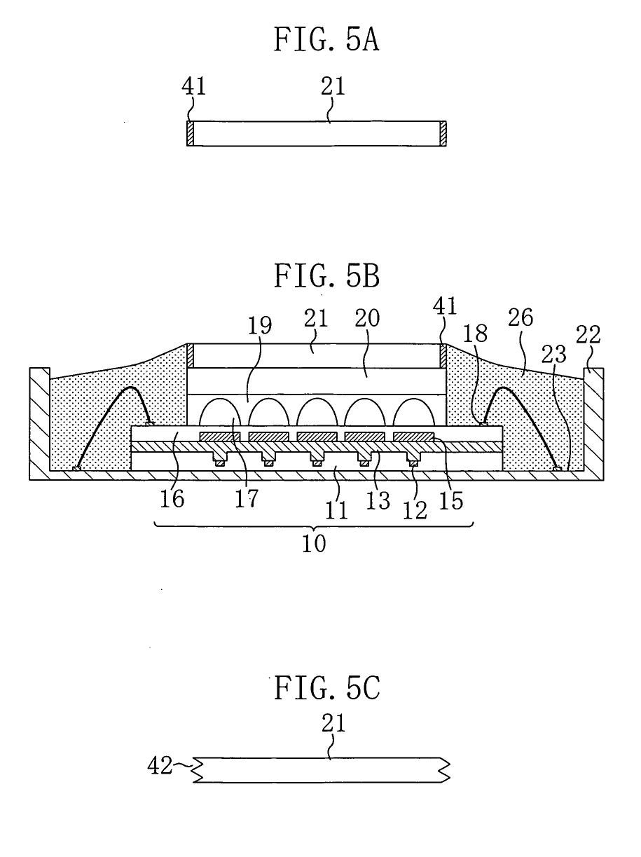

FIG. 5A is a sectional view illustrating an enlargement of a transparent component of a solid state imaging device according to a fourth embodiment of the present invention. FIG. 5B is a sectional view illustrating the overall structure of the solid state imaging device of the fourth embodiment. As shown in FIGS. 5A and 5B, the end faces of the transparent component 21 of the present embodiment are covered with anti-reflection films 41, respectively. Specifically, each of the anti-reflection films 41 exists between the end face of the transparent component 21 and the black resin 26. The structure shown in FIGS. 5A and 5B are the same as that of the first embodiment except the provision of the anti-reflection films 41. Therefore, detailed explanation is omitted.

If the transparent component 21 is made of glass, the anti-reflection films 41 may be made of an acrylic resin or an epoxy resin in which a filler is dispersed, SiON or SiN. If the acrylic or epoxy resin is used, the anti-reflection films 41 may be formed on the end faces of the transparent component 21 by dipping or coating. If SiON or SiN is used, the anti-reflection films 41 may be formed on the end faces of the transparent component 21 by vapor deposition.

According to a known technique, a coating film having a refractive index intermediate between the refractive indices of the transparent component 21 and air is formed on the top surface of the transparent component 21. Different from the known technique, in the present embodiment, the anti-reflection films 41 are formed on the end faces of the transparent component 21. The anti-reflection films 41 of the present embodiment may have a refractive index intermediate between the refractive indices of the transparent component 21 and the black resin. In particular, when the refractive indices of the transparent component 21 and the black resin 26 are n_{g} and n_{bk}, respectively, the refractive index of the anti-reflection films 41 is preferably brought close to (n_{g}/n_{bk})^{1/2}.

In the present embodiment, the provision of the anti-reflection films 41 makes it possible to prevent the light reached and reflected on the end faces of the transparent component 21 from entering the light receiving elements 12 with high reliability.

FIG. 5C is a sectional view illustrating a modified example of the transparent component according to the fourth embodiment. As shown in FIG. 5C, the end faces of the transparent component 21 may have rough surfaces 42 instead of forming the anti-reflection films 41 thereon. In this case, the light reached the end faces of the transparent component 21 is scattered by the rough surfaces 42. This modified example is also effective in that the light reached and reflected on the end faces of the transparent component 21 is prevented from entering the light receiving elements 12.

### Fifth Embodiment

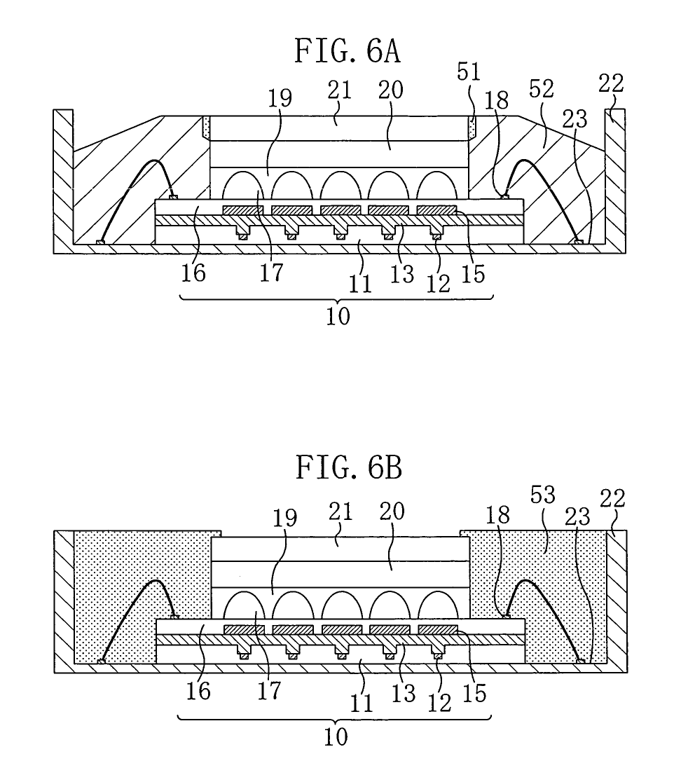

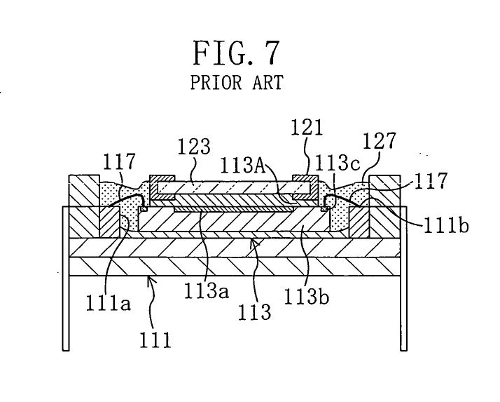

FIG. 6A is a sectional view illustrating the structure of a first solid state imaging device according to a fifth embodiment of the present invention. In FIG. 6A, a black resin 51 covers only the end faces of the transparent component 21 and a sealing resin 52 fills the space between the ceramic package 22 and the solid state imaging element. The sealing resin 52 may be a colorless resin free from any pigment or a resin mixed with a pigment of other color than black. With the structure shown in FIG. 6A, light reached the end faces of the transparent component 21 is absorbed by the black resin 51, thereby preventing the light from being reflected to enter the light receiving elements 12. In FIG. 6A, the black resin 51 covers only the end faces of the transparent component 21. That is, the black resin 51 covers the minimum required region. However, the black resin 51 may exist in other region than the minimum required region. As long as the end faces of the transparent component 21 are properly covered by the black resin 51, the remaining space between the ceramic package 22 and the solid state imaging element may be filled with the black resin or other resin than the black resin.

FIG. 6B is a sectional view illustrating the structure of a second solid state imaging device according to the firth embodiment of the present invention. In FIG. 6B, a black resin 53 not only fills the space between the ceramic package 22 and the solid state imaging element but also covers the edge of the top of the transparent component 21. The black resin 53 may cover all or part of the top edge of the transparent component 21. However, when viewed in plan, it is preferred that the black resin 53 does not cover a region where the microlenses 17 are provided (effective pixel region). In other words, it is preferable that the black resin 53 covers the region outside the effective pixel region when viewed in plan. With the structure shown in FIG. 6B, the amount of light reaching the end faces of the transparent component 21 is reduced. Therefore, the amount of light reflected on the end faces of the transparent component 21 is also reduced.

### Other Embodiment

The transparent component 21 of the above-described embodiments is made of glass. However, it may be made of other material such as a resin.

In the present invention, the solid state imaging element 10 as explained in the above-described embodiments may be replaced with other kinds of solid state imaging elements. Specifically, the solid state imaging element used in the present invention requires at least the light receiving elements 12 and the microlenses 17. Therefore, the other components may be omitted.

The ceramic package 22 of the above-described embodiments is made of a stack of two or more ceramic plates. However, other kinds of packages may be used.

What is claimed is:

1. A solid state imaging device comprising:
a solid state imaging element including a plurality of light receiving elements and a plurality of microlenses formed above the light receiving elements;
a transparent component formed above the microlenses; and
a black resin provided on end faces of the transparent component.

2. The solid state imaging device of claim 1 further comprising a package having a recess, wherein
the solid state imaging element and the transparent component are placed in the recess of the package and
the black resin fills space between the package and a combination of the solid state imaging element and the transparent component.

3. The solid state imaging device of claim 1, wherein
the black resin contains a resin and particles for blocking visible light.

4. The solid state imaging device of claim 3, wherein
the particles for blocking visible light are a black pigment, a black dye or carbon particles.

5. The solid state imaging device of claim 1, wherein
the black resin also covers the edge of the top of the transparent component.

6. The solid state imaging device of claim 1, wherein
the periphery of the transparent component is positioned outside the periphery of a region where the microlenses are provided when viewed in plan and
the solid state imaging device satisfies
L≧(t₀+t₁)tan θ
wherein L is a horizontal distance from the end face of the transparent component to the periphery of the region where the microlenses are provided, θ is a maximum incident angle with respect to the transparent component, to is a thickness of the transparent component and t₁ is a vertical distance from the top surface of the light receiving element to the bottom surface of the transparent component.

7. The solid state imaging device of claim 1, wherein
at least part of the transparent component is tapered upward.

8. The solid state imaging device of claim 1, wherein
an anti-reflection film having a refractive index intermediate between the refractive indices of the transparent component and the black resin is provided between the end face of the transparent component and the black resin.

9. The solid state imaging device of claim 8, wherein
a film having a refractive index intermediate between the refractive indices of the transparent component and air is formed on the top surface of the transparent component, the refractive index of said film being different from that of the anti-reflection film.

10. The solid state imaging device of claim 1, wherein
the end faces of the transparent component have rough surfaces, respectively.

11. The solid state imaging device of claim 1, wherein
the transparent component and the black resin have substantially the same refractive index.
